(19) United States
(12) Patent Application Publication
(10) Pub. No.: US 2019/0089595 A1
(43) Pub. Date: Mar. 21, 2019

(54) AUTOMATIC SECURITY CONFIGURATION

(71) Applicant: Cyber 2.0 (2015) Ltd,, Yavne (IL)

(72) Inventor: EREZ KAPLAN HAELION, Rehovot (IL)

(73) Assignee: Cyber 2.0 (2015) Ltd, Yavne (IL)

(21) Appl. No.: 15/707,866

(22) Filed: Sep. 18, 2017

(51) Int. Cl. H04L 12/24; H04L 29/06

(52) U.S. Cl. CPC H04L 41/0893; G06F 21/44; H04L 63/20; H04L 41/16

(57) ABSTRACT

A method, a computerized apparatus and a computer program product for automatic generation of security configuration and deployment thereof. The method comprises monitoring programs executed by a device within an organizational network, to identify an attempt to transmit outgoing communications. In response to determining a program executed by the device is attempting to transmit an outgoing communication: checking whether the program is listed in a base list of authorized programs. In response to determining that the program is listed in the base list, adding the program to a list of authorized programs.

### TECHNICAL FIELD

The present disclosure relates to computer security in general, and to automatic generation of security configuration and deployment thereof, in particular.

### BACKGROUND

A security configuration in systems engineering may define the authorized processes, programs and devices that compose the system and its boundary. The security configuration may be generated by an administrator of the system. The administrator of the system may be entrusted with the manual definition of the security configuration. Such manual task may proofed to be an intensive task that requires a substantial amount of effort and time.

The system administrator may manually configure parameters and initial settings for some computer programs, define which programs are allowed to be executed in the organization, define which users are allowed to use some programs, set user permissions for different programs, define security policy of the system, configure server processes and set operating system settings.

Manually generating a security configuration by a system administrator may be a pug-prone process that requires repeated verification and supervision. A significant number of iterations may be required to ensure a comprehensive and reliable security configuration. In many cases, only after the security configuration is completely verified, the security definition may be applied, so as to reduce the likelihood of an incorrect configuration being deployed and potentially paralyze the organization.

To the best knowledge of the inventors, no automatic methods for creating security configurations are known in system engineering, and manual labor is required to define the configurations of such systems. Such manual tasks often delay deployment of new security systems by weeks and even months.

### BRIEF SUMMARY

One exemplary embodiment of the disclosed subject matter is a method comprising: monitoring programs executed by a device within an organizational network, to identify an attempt to transmit outgoing communications; in response to determining a program executed by the device is attempting to transmit an outgoing communication: checking whether the program is listed in a base list of authorized programs; in response to determining that the program is listed in the base list, adding the program to a list of authorized programs.

Optionally, prior to checking whether the program is listed in the base list, checking whether the program is listed in the list, wherein said checking whether the program is listed in the base list is performed in response to determining that the program is not listed in the list.

Optionally, in response to determining that the program is not listed in the list, blocking the outgoing communication, whereby preventing the program from transmitting the outgoing communication.

Optionally, said blocking is performed prior to said checking whether the program is listed in the base list.

Optionally, the method further comprising allowing the program to transmit the outgoing communication.

Optionally, the method further comprising: in response to determining that a second program is attempting to transmit a second outgoing communication: checking whether the second program is listed in the list; in response to determining that the second program is not listed in the list: checking whether the second program is listed in the base list; and in response to determining that the second program is not listed in the base list, blocking the second outgoing communication, whereby preventing the second program from transmitting the second outgoing communication.

Optionally, the method further comprising: in response to determining that a second program is attempting to transmit a second outgoing communication: checking whether the second program is listed in the list; and in response to determining that the second program is listed in the list, allowing the second program to transmit the second outgoing communication, whereby avoiding checking whether the second program is listed in the base list.

Optionally, the method further comprising utilizing the list as a whitelist for a security-related tool that is operating within the organizational network.

Optionally, the security-related tool is a firewall.

Optionally, said utilizing comprises transmitting the list to the plurality of devices, each of which having the security-related tool installed thereon, wherein the security-related tool is configured to perform selective blocking of communications of programs based on the list.

Another exemplary embodiment of the disclosed subject matter is a computerized apparatus having a processor, the processor being adapted to perform the steps of: monitoring programs executed by a device within an organizational network, to identify an attempt to transmit outgoing communications; in response to determining a program executed by the device is attempting to transmit an outgoing communication: checking whether the program is listed in a base list of authorized programs; in response to determining that the program is listed in the base list, adding the program to a list of authorized programs.

Optionally, prior to checking whether the program is listed in the base list, checking whether the program is listed in the list, wherein said checking whether the program is listed in the base list is performed in response to determining that the program is not listed in the list.

Optionally, in response to determining that the program is not listed in the list, blocking the outgoing communication, whereby preventing the program from transmitting the outgoing communication.

Optionally, said blocking is performed prior to said checking whether the program is listed in the base list.

Optionally, the processor is further adapted to allow the program to transmit the outgoing communication.

Optionally, processor is further adapted to perform the steps of: in response to determining that a second program is attempting to transmit a second outgoing communication: checking whether the second program is listed in the list; in response to determining that the second program is not listed in the list: checking whether the second program is listed in the base list; and in response to determining that the second program is not listed in the base list, blocking the second outgoing communication, whereby preventing the second program from transmitting the second outgoing communication.

Optionally, the processor is further adapted to perform the steps of: in response to determining that a second program is attempting to transmit a second outgoing communication: checking whether the second program is listed in the list; and in response to determining that the second program is listed in the list, allowing the second program to transmit the second outgoing communication, whereby avoiding checking whether the second program is listed in the base list.

Optionally, the processor is further adapted to utilize the list as a whitelist for a security-related tool that is operating within the organizational network.

Optionally, said utilizing comprises transmitting the list to the plurality of devices, each of which having the security-related tool installed thereon, wherein the security-related tool is configured to perform selective blocking of communications of programs based on the list.

Yet another exemplary embodiment of the disclosed subject matter is a computer program product comprising a non-transitory computer readable storage medium retaining program instructions, which program instructions when read by a processor, cause the processor to perform a method comprising: monitoring programs executed by a device within an organizational network, to identify an attempt to transmit outgoing communications; in response to determining a program executed by the device is attempting to transmit an outgoing communication: checking whether the program is listed in a base list of authorized programs; in response to determining that the program is listed in the base list, adding the program to a list of authorized programs.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of an organizational network, in accordance with some exemplary embodiments of the disclosed subject matter;

FIGS. 2A-2D show flowchart diagrams of methods, in accordance with some exemplary embodiments of the disclosed subject matter;

FIG. 3 shows a flowchart diagram of a method, in accordance with some exemplary embodiments of the disclosed subject matter; and

FIG. 4 shows a block diagram of an apparatus, in accordance with some exemplary embodiments of the disclosed subject matter.

### DETAILED DESCRIPTION

One technical problem dealt with by the disclosed subject matter is to automatically generate a security configuration for a system that is associated with an organization.

Security configuration are typically generated by a system administrator, such as an IT person, a sysadmin, or a person who is responsible for the upkeep, configuration, and reliable operation of devices within the system. The system administrator seeks to ensure that the uptime, performance, resources, and security of device in the system meet the needs of the users, without committing a security offence. To meet these needs, a system administrator may acquire, install, or upgrade computer components and software; provide routine automation; maintain security configurations; troubleshoot; train or supervise staff; or offer technical support for projects. However, configuring a system by a system administrator may a labor-intensive manual effort, which may be expensive and bug prone. In some cases, manual security configuration may require a substantial amount of time, such as weeks or months. In some cases, the security configuration may be required in order for a security solution, such as a firewall, an outgoing communication filter, an anti-virus program, or the like, may be activated and prevent potential cyber-related incidents in the organization.

Another technical problem is to deploy a security system that requires a list of predetermined authorized programs, without manually choosing the authorized programs. Some security systems, such as firewalls or filtering systems, may utilize whitelist of authorized programs that are allowed to transmit outgoing communications from a device or a network. Existing whitelists may be general and may comprise a large amount of irrelevant programs for the specific system. Manually choosing the authorized programs and compiling the whitelist from scratch may be a time consuming process. A long time may be required to objectively identify all authorized programs that may be executed in any of the devices of the organization. As the organization may have different types of users and devices, there may be a potentially large number of different use cases that may need to be manually explored and reviewed. Substantial amount of resources may be invested in such an investigation, postponing the date in which the configuration can be applied. Furthermore, as the manual task is time consuming, some manual handpicking of programs may be defunct by the time the configuration is applied. For example, consider a version of the web browser GOOGLE™ CHROME™ that is identified as a valid program that is allowed to transmit outgoing communications. By the time the configuration is applied, the identified version may no longer be available, may no longer be used, and may be replaced by another version that would also need to be included in the whitelist.

Yet, another technical problem dealt with by the disclosed subject matter is to deploy the security configuration over the system, in order to provide a configuration that prevents from security attacks.

In some exemplary embodiments, devices of the system may be connected to an organizational network associated with the organization. The security configuration may be required to be deployed over devices connected to the organizational network. The security configuration may comprise configurations associated with communications transmitted via the organizational network. Additionally or alternatively, the security configuration may be required to be adapted to each device connected to the organizational network based on requirements of the device.

One technical solution is to automatically generate a local list of authorized programs in the organizational network. The local list is generated based on monitored communications. Devices in the organizational network are monitored to identify outgoing communications issued by programs executed thereby. The local list may be deployed over devices in the organizational network, such as a security configuration for a security-related tool that is activated in the organizational network. As an example, the local list may serve as a whitelist of a firewall of the organizational network. The firewall may utilize the whitelist to prevent unauthorized programs from transmitting communications outside the organizational network, thereby preventing potential data leaks and mitigating a risk of a malicious program exploiting vulnerabilities in the organizational network. Additionally or alternatively, the local list may be deployed on each device of the system when an outgoing communication filter is activated. The outgoing communication filter may be a software-based or hardware-based monitoring device that monitors each outgoing communication and prevents from unauthorized programs from sending outgoing communications. In some exemplary embodiments, the outgoing communication filter may be configured to process outgoing communications only of authorized programs, such as by employing port scrambling on authorized communications and not employing such scrambling on communications issued by unauthorized programs.

In some exemplary embodiments, the local list may comprise programs that are authorized to transmit outgoing communications. In some exemplary embodiments, the outgoing communication may be transmitted from a device within the organizational network. The outgoing communication may be a communication directed at another device, either within the organizational network or external thereto. The local list may be generated based on outgoing communications transmitted by programs executed within the organizational network. The local list may be retained within the organizational network, such as by a server connected to the organizational network, on each device in the organizational network having a whitelist-based security tool installed thereon, or the like.

In some exemplary embodiments, programs executed by each device within the organizational network may be monitored, to identify an attempt to transmit outgoing communications. When an attempt to transmit an outgoing communication is determined, the program attempting to transmit the outgoing communication may be checked to determine if it is authorized to transmit outgoing communications. The authorization of the program to transmit outgoing communications may be determined based on the program being listed in a base list of authorized programs. In response to the program being listed in the base list, the program may be added to the local list.

In some exemplary embodiments, the base list may be located external to the organizational network. The base list may comprise programs that are pre-determined to be authorized to transmit outgoing communications, based on the programs service providers, general configurations, rules and parameters defined by IT administrators, whitelists, blacklists, malicious signature identification methods, or the like. The base list may be pre-determined and may be a general list, such as including all known non-malicious programs, all versions thereof, or the like. The base list may not be particularly associated with a type of organization, and may include programs of different fields, such as word processing program, web browsers, an image editor, a video editor, a numeral computing program (e.g., MATLAB™), or the like. As can be appreciated, it is unlikely a law firm organization would authorize or use the video editor, while it is similarly unlikely that a movie studio would employ the numeral computing program, which may be typically used by research organizations.

In some exemplary embodiments, the generated local list may be a sub-set of the base list. The local list may comprise programs that are originally listed in the base list. In some exemplary embodiments, the local list may comprise programs that are generally authorized and are observed to be relevant to the organizational network.

In some exemplary embodiments, after the local list is generated, the local list may be transmitted to one or more devices within the organizational network.

In some exemplary embodiments, a system in accordance with the disclosed subject matter may be deployed in a passive learning mode. During a passive learning mode deployment, the local list may be generated based on outgoing communications transmitted from programs executed by devices in the organizational network. During the passive learning mode, no decisions may be made regarding blocking or transmitting the outgoing communications. In some exemplary embodiments, during passive learning mode, the security system may not be actively attempting to protect the organization, and it may solely focus on learning the behavior of the organization for the purpose of generating the local list.

In some exemplary embodiments, the system may be deployed in a passive learning mode over only a portion of the devices in the organizational network. Other devices in the organizational network may not be monitored, during the learning phase of the behavior of the organization. In some exemplary embodiments, the portion of the devices may be a representative sample of the devices of the organization, such as including different types of devices having different associated users. The local list may be generated based on monitored communications of programs executed by all the devices in the portion of the devices. Each program executed by a device of the portion of devices and attempting to transmit an outgoing communication may be checked if listed in the base list, and accordingly may be added to the local list. After the local list is fully generated, the system may be activated and enforce the local list-based security configuration on all the devices in the organizational network, and not just the portion which were monitored during the learning phase.

Additionally or alternatively, a system in accordance with the disclosed subject matter may be deployed in an active learning mode. During an active learning mode deployment, in addition to generating the local list based on monitored communications, the system may be active in attempting to mitigate security risks. In some exemplary embodiments, the system may selectively block the outgoing communications based on intermediate security configurations. In some exemplary embodiments, the selective blocking may be based on an intermediate version of the local list, as is currently available, or may be based on the base list, which is remotely accessible, potentially incurring substantive delay in accessing thereof.

In some exemplary embodiments, a determination that a program attempting to transmit an outgoing communication is not listed in the local list may be performed before checking whether the program is listed in the base list. In case the program is already listed in the local list, the outgoing communication may be allowed to be transmitted, and checking in the base list may be avoided. In some exemplary embodiments, there may be no need to update the local list, as the program is already determined to be listed therein. In case the program is not listed in the local list, it may be checked whether the program is listed in the base list. In case the program is listed in the base list, the outgoing communication may be allowed to be transmitted (e.g., not blocked). Additionally or alternatively, the program may be added to the local list. In case the program is not listed in the base list, the outgoing communication may be blocked, thereby mitigating the risk associated with allowing the transmission to be performed.

In some exemplary embodiments, in case the program is not listed in the local list, the outgoing communication may be initially blocked and the program may be prevented from transmitting the outgoing communication. The selective blockage may be based solely on the local list, which may be locally available, or at least not require a substantial delay in reaching thereof. After the outgoing communication is blocked, the base list may be examined to determine whether the base list includes the program. In case the program is listed in the base list, the local list may be then updated to contain the program. In some exemplary embodiments, after the program is initially forbidden from transmitting the outgoing communication, the program may attempt to transmit the outgoing communication again. Such may be the case, for example, if the blockage is implemented in a manner that indicates potentially temporary problem, such as a timeout, a network connectivity issue, or the like. Additionally or alternatively, the program may be configured to make several attempts to transmit the outgoing communication regardless to the reason the previous attempts were unsuccessful. If in the meantime, between the blockage of the first attempt and a next attempt, the local list is already updated to include the program, the outgoing communication may be allowed to be transmitted. In some exemplary embodiments, the repeated attempts may be performed within a relatively short time frame, such as within less than 100 milliseconds, 0.5 second, 2 seconds, or the like. The user of the device may therefore may be delayed for a relatively short time period and may be unaware of the initial security-based blockage and may practically not be affected by such blockage.

In some exemplary embodiments, the local list may be transmitted to one or more devices within the organizational network after being generated. A determination that generating of the local list is completed may be performed based on the local list not being updated for a number of successive attempts to transmit outgoing communications that is above a predetermined threshold, such as about 10 attempts, about 50 attempts, about 200 attempts, or the like. Additionally or alternatively, the stopping condition may be based on a number of attempts from each monitored device, which may be provided either in absolute numbers, relative number, a combination thereof, or the like. Additionally or alternatively, the stopping condition of the learning phase may be a predetermined amount of time elapsing from the last update of the local list, such as no update within about 12 hours, about 3 days, about one week, or the like. It may be noted that in some exemplary embodiments the local list may not be updated in response to an attempt to transmit an outgoing communications in two cases: the first, the program attempting to transmit the outgoing communication is already authorized and listed in the local list; the second, the program attempting to transmit the outgoing communication is not listed in the base list. Additionally or alternatively, a determination that generating of the local list is completed, may be performed based on a user input, such as an IT administrator input, based on reaching a threshold on the size of the local list, or the like.

In some exemplary embodiments, the local list may be utilized by a firewall device of the organizational network. The firewall device may be configured to monitor and control incoming and outgoing network traffic of the organizational network based on predetermined security rules associated with the local list. As an example, the firewall device may prevent programs that are not listed in the local list from passing any data packets from within the organizational network externally thereof.

Additionally or alternatively, the local list may be utilized by outgoing communication filters of one or more devices to perform selective blocking of outgoing communications of programs executed thereon. An outgoing communication filter of a device may be configured to block outgoing communication of programs executed by the device that are not listed in the local list.

One technical effect of utilizing the disclosed subject matter is to leverage a pre-prepared base list of authorized programs to provide an organization-specific tailor list. The base list may be of a potential large volume, such as including gigabytes or even terabytes of information. The base list may include many programs, and different versions thereof. The base list may include for each executable of each version of each program, a signature, such as hash value, allowing for relatively secure validation integrity of an executed program against the base list. Much of the information retained in the base list may be irrelevant to the organization in which the security configuration is to be applied. Utilizing the generated local list is more efficient than the pre-prepared base list, as it may be smaller and may comprise only programs that are relevant for the organization. Program lookup in local list may be substantially faster than a corresponding lookup in the base list. Furthermore as the size of the local list may be considerably smaller, such as in kilobytes or few megabytes, it may be plausible to retain the local list in one or more devices. Furthermore, much of the bandwidth which may be required to download the base list to a local device within the organization is spared, as well as the storage space. Further still, the local list may be duplicated and retained in different devices, such as for example in each device being monitored. Since the local list is of significant smaller size, the storage overhead is significantly reduced, while still including potentially all relevant information to the organization. Furthermore, the reduced size may also allow for providing an integrity signature of the local list that can be computed significantly faster than a corresponding signature of the much larger, base list.

Another technical effect of utilizing the disclosed subject matter is to improve performance of security configurations, and allow the deployment thereof to be practical. Base lists or databases of authorized programs, may be too big for being stored locally by the system. In some exemplary embodiments, it may take a long time to send an authorization query of each program to be handled by an external server before any attempt to transmit an outgoing communication. Retaining a local list internally within the organization, and limiting it to include only authorized programs that are observed to be relevant to the organization, may allow the system to effectively operate and check authorization in a short timeframe and provide an efficient process.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

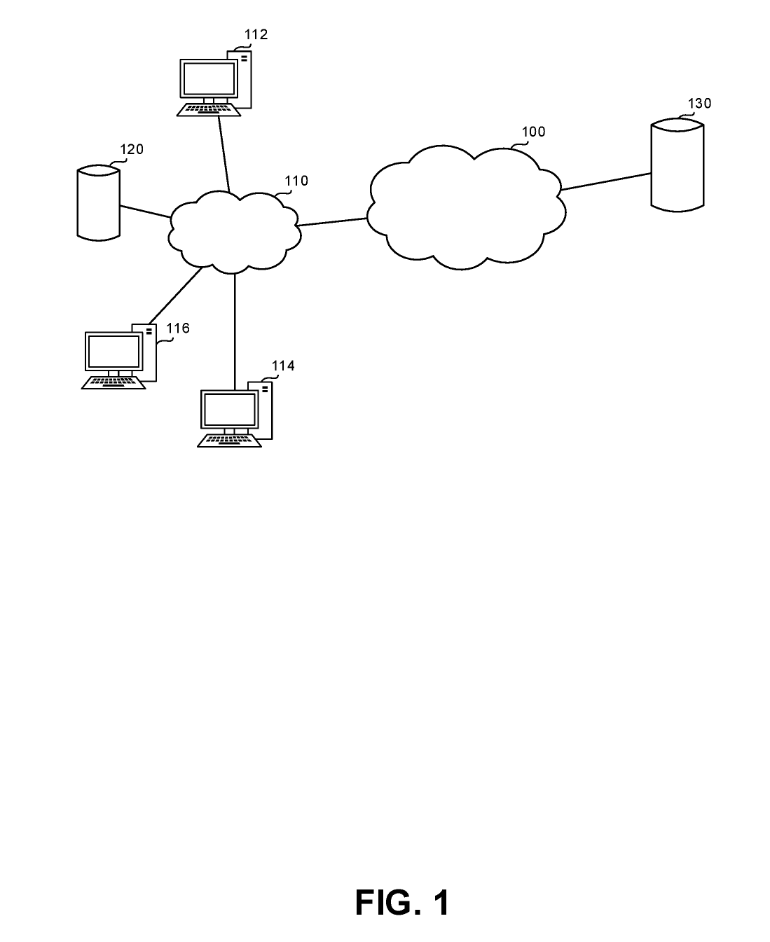

Referring now to FIG. 1 showing a schematic illustration of organizational network, in accordance with some exemplary embodiments of the disclosed subject matter.

In some exemplary embodiments, an Organizational Network 110 may comprise a plurality of computerized devices, such as Devices 112, 114 and 116, interconnected to one another and sharing resources, such as, for example, through common access to one or more servers (not shown) connected to Organizational Network 110.

In some exemplary embodiments, Network 110, such as intranet, Local Area Network (LAN), Wi-Fi network, or the like, may be connected to External Network 100, such as a Wide Area Network (WAN), the Internet, or the like. In some cases, Organizational Network 110 may be connected to External Network 100 by a router, switch, server or the like. In some exemplary embodiments, a gateway device may be configured to provide some security measures to prevent malicious activity. In some exemplary embodiments, the gateway device may be a firewall or otherwise provide the functionality of a firewall. The firewall may monitor incoming and outgoing communications in and from Organizational Network 110, and selectively prevent packets from passing from on network to the other. In some cases, the firewall may rely on a whitelist of allowed programs, a blacklist of banned programs, or the like.

In some exemplary embodiments, Devices 112, 114 and 116 may be computerized devices, such as personal computers, smartphones, servers, Internet of Things (IoT) devices, or the like. Two such devices may be networked together when one device is able to exchange information with the other device, whether or not they have a direct connection to each other. Devices 112, 114 and 116 may exchange data with each o other using data links. The connections between Devices 112, 114 and 116 may be established using either a wired connection, a wireless connection, or combination thereof. In some exemplary embodiments, Organizational Network 110 may enable sharing of resources between devices connected thereto, such as a shared storage space, a shared printer, or the like.

In some exemplary embodiments, Organizational Network 110 may be an intranet network of an organization, such as a governmental institution, a business organization, or the like. Devices 112, 114 and 116 may operate as a part of the organization, or be associated with users thereof.

In some exemplary embodiments, programs authorized to transmit outgoing communications from devices in Organizational Network 110 may be listed in a Local List 120. Local List 120 may be retained by the organization and accessible by devices connected to Organizational Network 110. Additionally or alternatively, Local List 120 may be transmitted to each or some of the devices of Organizational Network 110, and retained therein. As an example, each device of Devices 112, 114, 116 may locally retain a separate duplicate copy of Local List 120. In some exemplary embodiments, Local List 120 may comprise identifiers of authorized software applications or programs that are permitted to act on devices within Organizational Network 110. The identifiers may be, for example, executable names, a verifiable signature of the executable (e.g., hash of the executable), a unique identifier, or the like. In some exemplary embodiments, Local List 120 may be generated and updated based on observed outgoing communications from Devices 112, 114 and 116, such transmissions exiting a device and reaching another device, either within the Organizational Network 110 or external thereto, such as in External Network 100. Additionally or alternatively, the disclosed subject matter may be utilized to monitor only outgoing communications that cross over from Organizational Network 110 to External Network 100.

In some exemplary embodiments, Local List 120 may be used as part of a security configuration of Organizational Network 110. As an example, Local List 120 may be used as a whitelist. In some exemplary embodiments, only programs that are listed in Local List 120 may be authorized to transmit outgoing communication from devices within Organizational Network 110. Additionally or alternatively, the whitelist may be used by a firewall of Organizational Network 110.

In some exemplary embodiments, Local List 120 may be a subset of a Base List 130. Base list 130 may be a list of authorized programs that is general and not associated with any specific organization. Base List 130 may be retained in a storage external to the organization and may be accessed via External Network 100. Base List 130 may comprise programs or applications that have been approved to be protected against malicious activity, programs that are approved to be authorized, or the like. As an example, Base List 130 may include all programs published by trusted vendors, all versions thereof, or the like.

In some exemplary embodiments, programs executed by each of Devices 112, 114 and 116, may be monitored to identify any attempt to transmit outgoing communications. When an attempt to transmit an outgoing communication, by a program executed by one of Devices 112, 114 or 116, is identified, a determination whether the program is listed in Base List 130 may be performed. In response to determining that the program is listed Base List 130, the program may be added to Local List 120. As a result, Local List 120 is generated as a subset of Base List 130, and based on observed activity within Organizational Network 110.

In some exemplary embodiments, prior to checking whether a program intending to transmit a communication is listed Base List 130, the program may be initially checked whether is listed in Local List 120. In case the program is already listed in Local List 120. Only if the program is not listed in Local List 120, is Base List 130 examined.

In some exemplary embodiments, in case the program is not listed in the Local List 120, the outgoing communication may be blocked. After blocking the outgoing communication, the program may be checked in Base List 130 and added to Local List 120 in case is listed in Base List 130. In some exemplary embodiments, the program may be configured to make additional attempts to transmit the outgoing communication. The additional attempts may be performed in case the previous attempts were unsuccessful, regardless to the reason of their failure. The additional attempts may be performed within a relatively short time frame after the previous unsuccessful attempt, such as after a predetermined timeout has elapsed. In case the program is authorized, the program will be added to Local List 120. The next attempts to transmit the outgoing communication after the program is added to Local List 120 may be allowed to be transmitted. The outgoing communication may be delayed for a relatively short time period, and the initial blockage may not affect performance of the program. Additional communications of the program may be allowed to be transmitted. In some exemplary embodiments, from the perspective of the user, the delay may appear to be similar to that which she may encounter, such as in case of network congestion, connectivity problems, or the like.

In some exemplary embodiments, after Local List 120 is generated, Local List 120 may be transmitted to Devices 112, 114 and 116. Local List 120 may be utilized as a whitelist for a security-related tool (not shown) that is operating in Organizational Network 110. The security related tool may operate over Organizational Network 110, over a specific device in Organizational Network 110, over a portion of the devices within Organizational Network 110, or the like. Programs that are listed in Local List 120, may be allowed to transmit outgoing communications from Devices 112, 114 or 116, without checking whether are listed in Base List 130.

In some exemplary embodiments, Local List 120 may be utilized by a firewall device of Organizational Network 110 (not shown). The firewall device may prevent programs that are not listed in Local List 120 from transmitting outgoing communications from Organizational Network 110.

Additionally or alternatively, Local List 120 may be provided to an outgoing communication filter of Devices 112, 114 or 116. The outgoing communication filter may be utilized to perform selective blocking of outgoing communications of programs within Organizational Network 110. The outgoing communication filter may prevent programs that are not listed in Local List 120 from transmitting outgoing communications.

In some exemplary embodiments, Local List 120 may be generated based on monitored outgoing communications transmitted from programs executed by a portion of the devices connected to Organizational Network 110, such as based only on outgoing communications transmitted from programs executed by Device 112. After being generated, Local List 120 may be transmitted to Device 114 and Device 116, and utilized by security relating tools thereof. In some exemplary embodiments, the portion of the devices may be a representative sample of the entire population of devices in Organization Network 110, such as comprising representatives of different types of devices, and of users associated therewith. In some exemplary embodiments, each sub-group may be represented by at least one device in the sample, while not necessarily maintaining the ratio between the different sub-groups as is observed in the population.

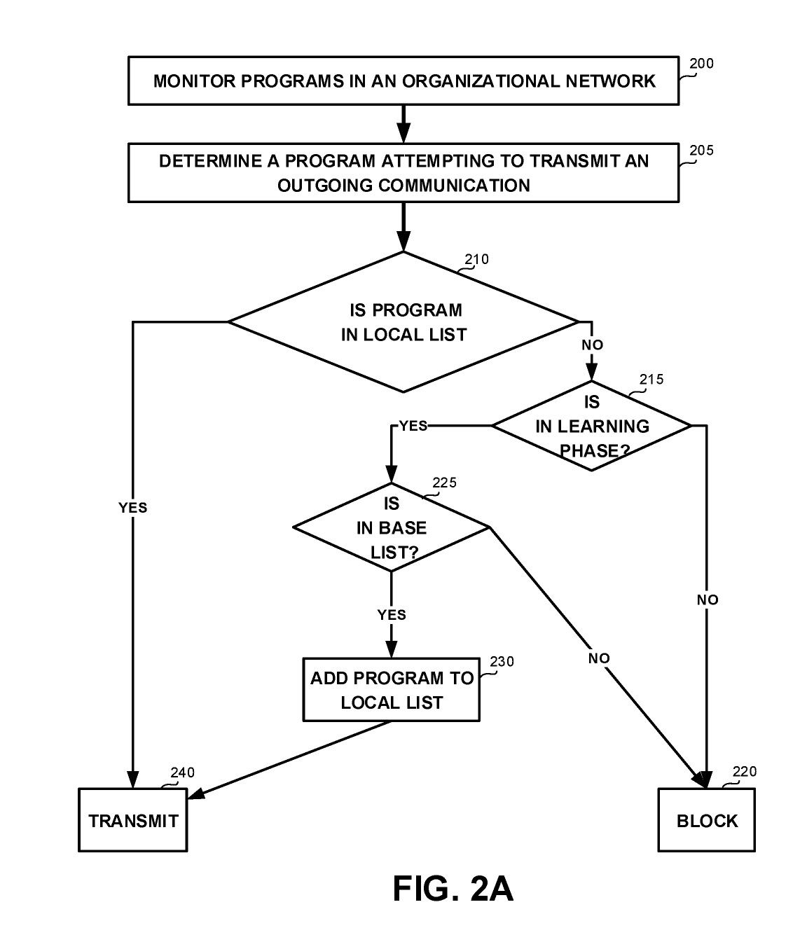

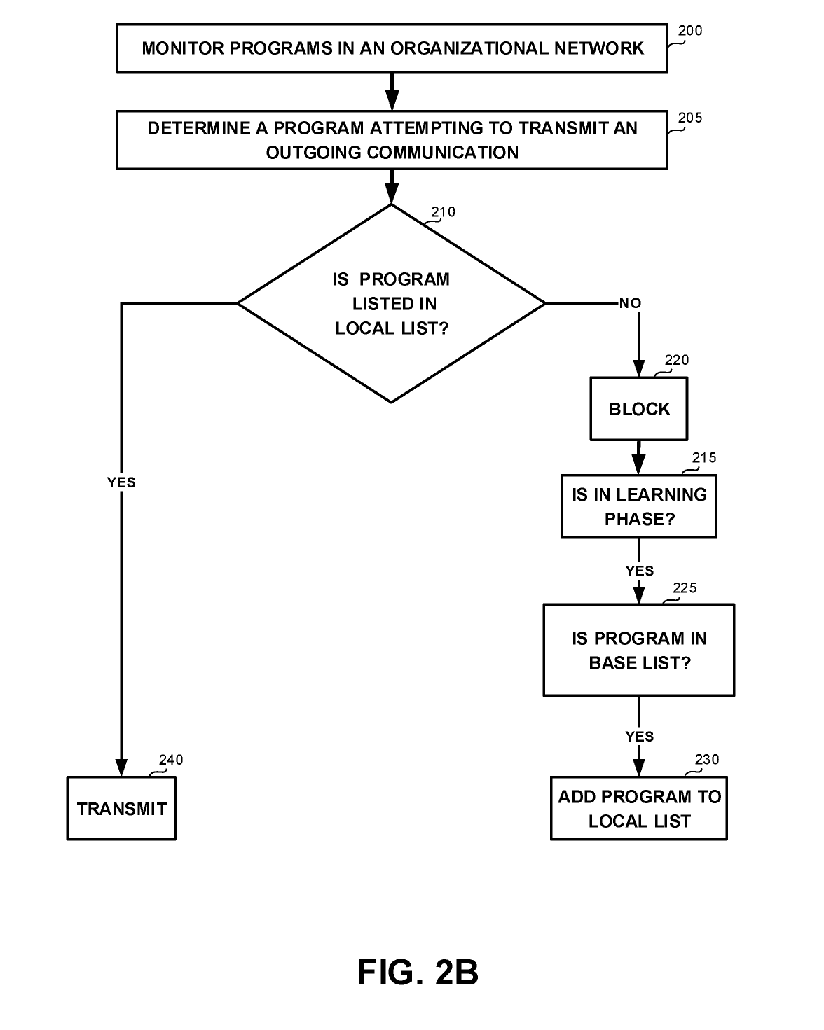

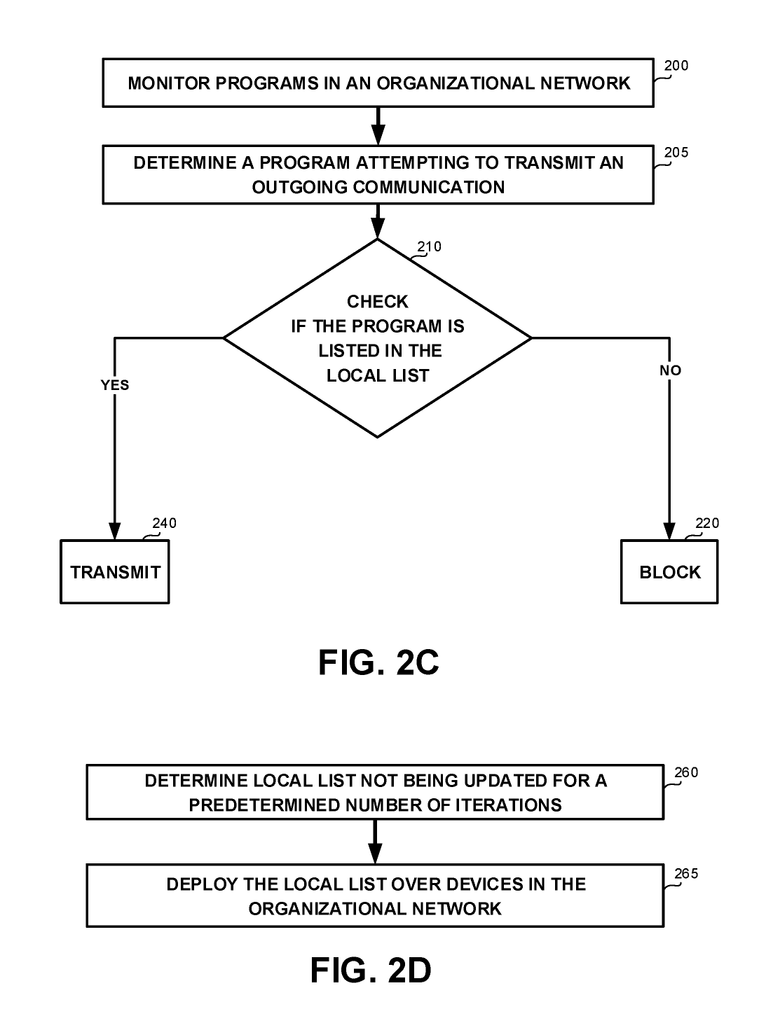

Referring now to FIG. 2A showing a flowchart diagram of a method, in accordance with some exemplary embodiments of the disclosed subject matter.

On Step 200, programs in an organizational network such as 110 in FIG. 1, may be monitored to identify an attempts to transmit outgoing communications. In some exemplary embodiments, the organizational network may comprise a plurality of devices, such as Devices 112, 114 and 116 in FIG. 1. The organizational network may be associated with an organization. Each device may execute programs that are relevant to the functionality of the organization. In some exemplary embodiments, monitoring may be performed with respect to all of the devices in the organization, a sample thereof, or the like.

On Step 205, a program attempting to transmit an outgoing communication may be determined. The program may be executed by a device connected to the organizational network. In some exemplary embodiments, the outgoing communication may be directed to another device within the same organizational network or directed outside the organizational network, such as outside a Local Area Network (LAN) and to a web-server connectable to the LAN via the Internet.

On Step 210, a determination whether the program is listed in a local list, such as 120 of FIG. 1, may be performed. The local list may comprise programs that are authorized to transmit outgoing communications within and outside the organizational network. In some exemplary embodiments, the local list may define a security configuration of the organizational network.

In case the program is listed in the local list, Step 240 may be performed and the program may be allowed to transmit the outgoing communication.

On Step 215, in case the program is not listed in the local list, a determination whether the system performing the method depicted in FIG. 2A is in a learning phase may be performed. During a learning phase, the local list may be potentially updated based on outgoing communications transmitted from programs executed by devices in the organizational network.

On Step 220, in case the system is not in a learning phase, the outgoing communication may be blocked. In some exemplary embodiments, determinations whether to transmit communications or not may be solely performed based on the program transmitting the outgoing communication being listed in the local list. In some exemplary embodiments, when the system is not in a learning phase, the disclosed subject matter may be part of a security system protecting the organizational network based on security configuration defined by the local list.

On Step 225, in case the system is during a learning phase, the program may be checked whether is listed in a base list of authorized programs. In some exemplary embodiments, during the learning phase, in response to determining that the program is not listed in the local list, prior to blocking the outgoing communication, a base list may be used to check whether the program should be added to the local list. The base list may be a general whitelist of authorized programs, such as 130 of FIG. 1. The base list may be retained external to the organizational network, such as in a remote storage that is not directly connected to the organizational network. In some cases, the base list may be used by several different systems (or instances thereof) deployed in different organizations at the same time.

In case the program is not listed in the base list, the outgoing communication may be blocked (Step 220) and the program may be prevented from transmitting the outgoing communication. Otherwise, in case the program is listed in the base list, on Step 230, the program may be added to the local list, so that in future cases where the same program attempts to transmit an outgoing communication it will be allowed based on the local list and without having to consult the base list. In case the program is in the base list, the program may be allowed to transmit the outgoing communication (Step 240).

It may be appreciated that in some exemplary embodiments, the method depicted in FIG. 2A may be performed without performing Step 240 or Step 260. In some exemplary embodiments, on Step 215, the system performing the method may be determined to be deployed in a passive learning mode. During the passive learning mode, no blocking decisions may be made and all outgoing communications may be allowed to be transmitted.

Referring now to FIG. 2B showing a flowchart diagram of a method, in accordance with some exemplary embodiments of the disclosed subject matter.

In some exemplary embodiments, during a learning mode deployment, in addition to generating the local list based on monitored communications, the system may selectively block outgoing communications based on an intermediate version of the local list, as is currently available.

On Step 210, it may be checked whether the program is listed in the local list. In case the program is not listed in the local list, the outgoing communication may be blocked (Step 220). The outgoing communication may be blocked even if the program is listed in the base list.

On Step 215, a determination whether the local list is in a learning phase may be performed. During the learning phase, the base list may be consulted (Step 225) and in case the program is listed therein, the program may be added to the local list (Step 230). When the system is not operating in learning phase, the base list may not be consulted.

In case the program attempts to transmit the outgoing communication again, such as retransmission attempts that may be associated with potential timeouts, the local list may be consulted. However, as the local list was potentially updated on Step 230, the program may be listed, and the transmission may be allowed (Step 240). Hence, during an active learning phase, a first transmission from a program that was not observed before may be blocked, and a second transmission may be allowed, depending on whether the program is indeed listed in the base list.

Referring now to FIG. 2C showing a flowchart diagram of a method, in accordance with some exemplary embodiments of the disclosed subject matter.

After the local list is deployed, authorization of programs to transmit communications may be determined based on the programs being listed in the local list, while avoiding checking the base list. In some exemplary embodiments, the system may be said to be in active, non-learning, phase. In such a deployment in response to a monitored outgoing transmission attempt (200), the program attempting to transmit is identified (205), and such program is checked against the local list (210). Solely based on such check, it is determined whether to allow the transmission (240) or block it (220).

Referring now to FIG. 2D showing a flowchart diagram of a method, in accordance with some exemplary embodiments of the disclosed subject matter. In some exemplary embodiments, FIG. 2D exemplifies stopping criteria for changing from learning phase to non-learning phase.

On Step 260, a determination that the local list is not being updated for a predetermined number of iterations may be performed. In some exemplary embodiments, each attempt to transmit an outgoing communication that is monitored and processed by the disclosed subject matter may be considered an “iteration”. In case the local list is not updated for a long while, it may be assumed that the system had concluded learning the behavior of the organization and the local list can be used without consulting the base list from now on. Such a determination may conclude the learning phase. In some exemplary embodiments, the local list may not be updated because monitored programs are either already listed in the local list (e.g., and Step 210 determines they are listed), or they are not listed in both the local list and the base list (e.g., and Step 225 determines they are not listed in the base list). In some exemplary embodiments, the number of iterations in which the local list is not updated may be required to be successive in order for the stopping condition to be met. In some exemplary embodiments, the predetermined number of iterations may be, for example, about 50, about 100, about 200, or the like. Additionally or alternatively, the determination that the local list is not being updated may be performed based on a different stopping condition, such as a predetermined amount of time elapsing from the last update of the local list (the last iteration which Step 230 has been performed), based on a user input, based on reaching a threshold on the size of the local list, or the like.

On Step 265, the local list may be deployed over one or more devices in the organizational network. The local list may define a security configuration of the organizational network. The local list may comprise the programs that are authorized to transmit communications within the organizational network.

In some exemplary embodiments, the local list may be provided to a security related tool of the organizational network, such as firewall device. The firewall device may be configured to monitor outgoing network traffic of the organizational network and decides whether to allow or block specific traffic based on a defined set of security rules. The firewall device may utilize the local list as the set of security rules. The firewall device may prevent programs that are not listed in the local list from transmitting outgoing communications.

Additionally or alternatively, the local list may be provided to an outgoing communication filter utilized to perform selective blocking of communications of programs within the organizational network. The outgoing communication filter may prevent programs that are not listed in the list from transmitting outgoing communications.

It will be noted that the local list that is deployed may be the “final” version of the local list. In some exemplary embodiments, a plurality of local lists may be obtained from different devices and aggregated together to form the final version of the local list. In some cases, different devices that operate to gradually update the local list may share intermediate versions of the local lists. For example, in response to an update in one device, a local list in the device is updated and a notification to all other devices participating in the learning effort are notified to update their lists accordingly. Additionally or alternatively, batch updates may be transmitted periodically. Additionally or alternatively, the devices may share their updated local lists periodically to allow each device to compile a local list based on such updated local lists.

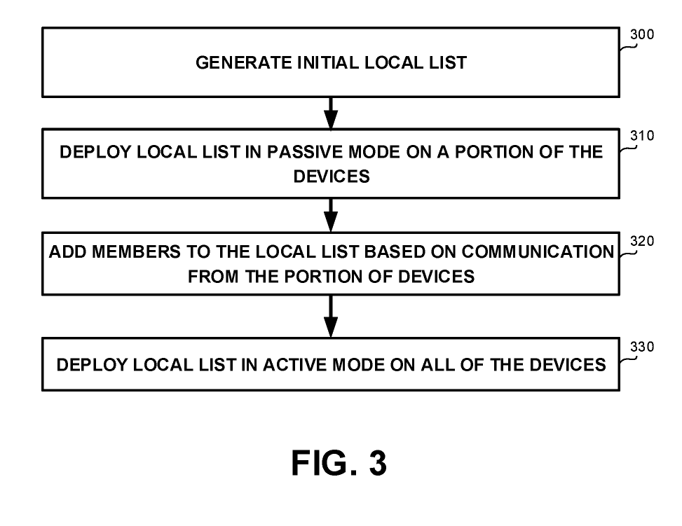

Referring now to FIG. 3 showing a flowchart diagram of a method, in accordance with some exemplary embodiments of the disclosed subject matter.

On Step 300, an initial local list may be generated. The initial local list may be a list of programs that are authorized to transmit communication within the organizational network. In some exemplary embodiments, the initial local list may be defined by IT administrators of the organizational network. The initial local list may comprise programs that has been previously determined to be authorized, such as based on being listed in known whitelists, based on the program configuration, or the like. In some exemplary embodiments, the initial local list may be an empty list that does not include any program.

On Step 310, the initial local list may be deployed in a passive mode over a portion of the devices. In some exemplary embodiments, the portion of devices may be a representative sample of the devices in the organizational network. While deploying the initial local list in passive mode, outgoing communications may be monitored but not blocked.

On Step 320, members may be added to the initial local list based on communications transmitted by programs executed by the portion of devices. While deploying the initial local list in passive mode, in response to determining an attempt to transmit an outgoing communication by a program executed by a device of the portion of devices, the program may be checked to determine if listed in the base list. In case the program is listed in the base list, the program may be added to the local list. In some exemplary embodiments, the local list may be updated by a central entity receiving information from all monitored devices. Additionally or alternatively, each device may maintain a different local list and update such list independently. The independent local lists may be combined together to create the finalized local list.

On Step 330, the local list may be deployed in active mode on all of the devices. While deploying the local list in active mode, in response to determining an attempt to transmit an outgoing communication by a program executed by any device in the organizational network, the program may be checked whether is authorized or not, only based on being listed in the local list. In some exemplary embodiments, the active mode may be learning active mode, where non-authorized programs are blocked but also checked against the base list for being included in the local list for future transmission attempts. Additionally or alternatively, the active mode may be a non-learning active mode, where the local list remains unchanged.

In some exemplary embodiments, a determination when to deploy the local list in active mode may be performed based on IT administrators decision, based on a size of the local list, based on the local list not being updated for a predetermined number of iterations (such as depicted in FIG. 2D), or the like.

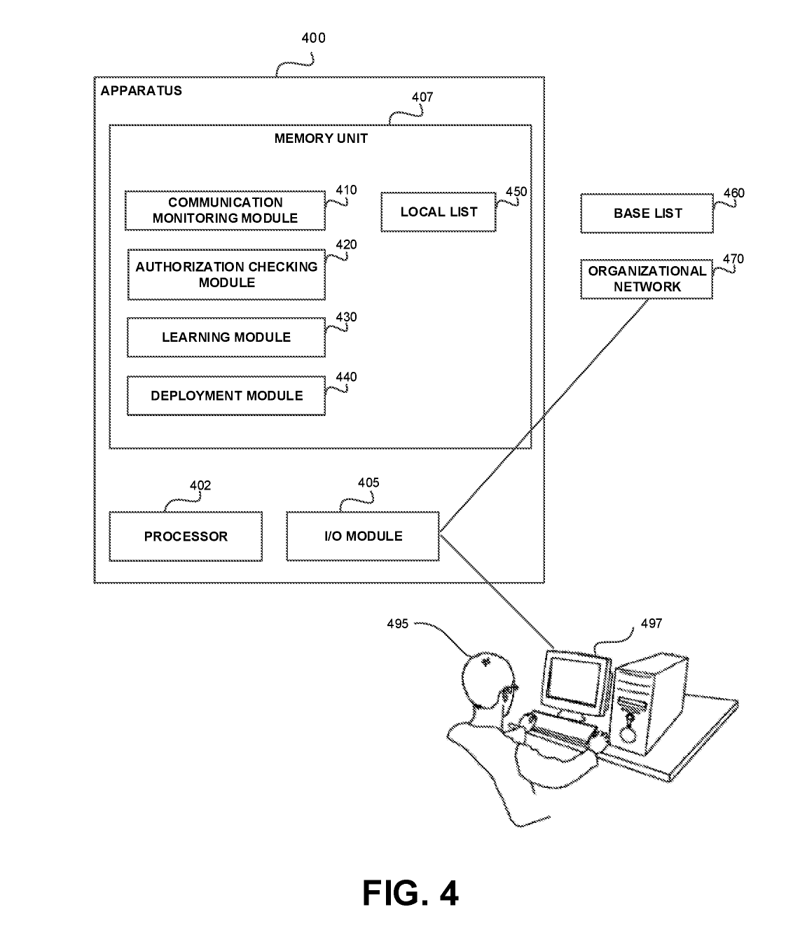

Referring now to FIG. 4 showing an apparatus, in accordance with some exemplary embodiments of the disclosed subject matter.

In some exemplary embodiments, Apparatus 400 may comprise one or more Processor(s) 402. Processor 402 may be a Central Processing Unit (CPU), a microprocessor, an electronic circuit, an Integrated Circuit (IC) or the like. Processor 402 may be utilized to perform computations required by Apparatus 300 or any of it subcomponents.

In some exemplary embodiments of the disclosed subject matter, Apparatus 400 is may comprise an Input/Output (I/O) module 405. Apparatus 400 may utilize I/O Module 405 as an interface to transmit and/or receive information and instructions between Apparatus 400 and external I/O devices, such as a Workstation 497, computer networks (not shown), or the like. In some exemplary embodiments, I/O Module 405 may be utilized to provide an output to and receive input from a User 495. It will be appreciated that Apparatus 400 can operate automatically without human intervention.

In some exemplary embodiments, Apparatus 400 may be connected to an Organizational Network 470. Organizational Network 470 may be associated with an organization. Additional devices (not shown) may be connected together within Organizational Network 470. In some exemplary embodiments, Apparatus 400 may be connected to Organizational Network 470 via I/O Module 405.

In some exemplary embodiments, Apparatus 400 may comprise Memory Unit 407. Memory Unit 407 may be a hard disk drive, a Flash disk, a Random Access Memory (RAM), a memory chip, or the like. In some exemplary embodiments, Memory Unit 407 may retain program code operative to cause Processor 402 to perform acts associated with any of the subcomponents of Apparatus 400.

In some exemplary embodiments, a Communication Monitoring Module 410 may be configured to monitor programs executed by a device within Organizational Network 470, to identify an attempt to transmit outgoing communications.

In response to Communication Monitoring Module 410 identifying a program attempting to transmit an outgoing communication, an Authorization Checking Module 420 may be configured to check whether the program is listed in a Base List 460 of authorized programs. Base List 460 may be maintained external to Organizational Network 470. In response to determining that the program is listed in Base List 460, a Learning Module 430 may be configured to add the program to a Local List 450.

In some exemplary embodiments, Authorization Checking Module 420 may be configured to check whether a program intending to transmit an outgoing communication is listed in Local List 450, prior to checking whether the program is listed in Base List 460. In response to determining that the program is not listed in Local List 450, Authorization Checking Module 420 may check whether the program is listed in Base List 460.

In some exemplary embodiments, in response to Authorization Checking Module 420 determining that the program is not listed in Local List 450, the program may be prevented from transmitting the outgoing communication. In some exemplary embodiments, the program may be reported using I/O Module 405 to a firewall device (not shown), to an outgoing communication filter of Organizational Network 470, to an administrator of Organizational Network 470, or the like. In some exemplary embodiments, the program may be blocked prior to Authorization Checking Module 420 checking whether the program is listed in the base list.

In some exemplary embodiments, a Deployment Module 440 may be configured to deploy Local List 450 over the devices within Organizational Network 470. Local List 450 may define a security configuration of Organizational Network 470.

In some exemplary embodiments, Deployment Module 440 may be configured to send Local List 450 to a firewall device (not shown) of Organizational Network 470. The firewall device may be configured to prevent programs that are not listed in Local List 450 from transmitting outgoing communications within Organizational Network 470.

Additionally or alternatively, Deployment Module 440 may be configured to provide Local List 450 to an outgoing communication filter (not shown). The outgoing communication filter may be utilized to perform selective blocking of communications of programs within Organizational Network 470. The outgoing communication filter may be configured to prevent programs that are not listed in Local List 450 from transmitting outgoing communications within Organizational Network 470.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
monitoring programs executed by a device within an organizational network, to identify an attempt to transmit outgoing communications;
in response to determining a program executed by the device is attempting to transmit an outgoing communication:
checking whether the program is listed in a base list of authorized programs;
in response to determining that the program is listed in the base list, adding the program to a list of authorized programs.

2. The method of claim 1, wherein prior to checking whether the program is listed in the base list, checking whether the program is listed in the list, wherein said checking whether the program is listed in the base list is performed in response to determining that the program is not listed in the list.

3. The method of claim 2, wherein in response to determining that the program is not listed in the list, blocking the outgoing communication, whereby preventing the program from transmitting the outgoing communication.

4. The method of claim 3, wherein said blocking is performed prior to said checking whether the program is listed in the base list.

5. The method of claim 1, further comprising allowing the program to transmit the outgoing communication.

6. The method of claim 1, further comprising:
in response to determining that a second program is attempting to transmit a second outgoing communication:
checking whether the second program is listed in the list;
in response to determining that the second program is not listed in the list:
checking whether the second program is listed in the base list; and
in response to determining that the second program is not listed in the base list, blocking the second outgoing communication, whereby preventing the second program from transmitting the second outgoing communication.

7. The method of claim 1, further comprising:
in response to determining that a second program is attempting to transmit a second outgoing communication:
checking whether the second program is listed in the list; and
in response to determining that the second program is listed in the list, allowing the second program to transmit the second outgoing communication, whereby avoiding checking whether the second program is listed in the base list.

8. The method of claim 1, further comprising utilizing the list as a whitelist for a security-related tool that is operating within the organizational network.

9. The method of claim 8, wherein the security-related tool is a firewall.

10. The method of claim 8, wherein said utilizing comprises transmitting the list to the plurality of devices, each of which having the security-related tool installed thereon, wherein the security-related tool is configured to perform selective blocking of communications of programs based on the list.

11. A computerized apparatus having a processor, the processor being adapted to perform the steps of:
monitoring programs executed by a device within an organizational network, to identify an attempt to transmit outgoing communications;
in response to determining a program executed by the device is attempting to transmit an outgoing communication:
checking whether the program is listed in a base list of authorized programs;
in response to determining that the program is listed in the base list, adding the program to a list of authorized programs.

12. The computerized apparatus of claim 11, wherein prior to checking whether the program is listed in the base list, checking whether the program is listed in the list, wherein said checking whether the program is listed in the base list is performed in response to determining that the program is not listed in the list.

13. The computerized apparatus of claim 12, wherein in response to determining that the program is not listed in the list, blocking the outgoing communication, whereby preventing the program from transmitting the outgoing communication.

14. The computerized apparatus of claim 13, wherein said blocking is performed prior to said checking whether the program is listed in the base list.

15. The computerized apparatus of claim 11, wherein the processor is further adapted to allow the program to transmit the outgoing communication.

16. The computerized apparatus of claim 11, wherein the processor is further adapted to perform the steps of:
in response to determining that a second program is attempting to transmit a second outgoing communication:
checking whether the second program is listed in the list;
in response to determining that the second program is not listed in the list:
checking whether the second program is listed in the base list; and
in response to determining that the second program is not listed in the base list, blocking the second outgoing communication, whereby preventing the second program from transmitting the second outgoing communication.

17. The computerized apparatus of claim 11, wherein the processor is further adapted to perform the steps of:
in response to determining that a second program is attempting to transmit a second outgoing communication:
checking whether the second program is listed in the list; and
in response to determining that the second program is listed in the list, allowing the second program to transmit the second outgoing communication, whereby avoiding checking whether the second program is listed in the base list.

18. The computerized apparatus of claim 11, wherein the processor is further adapted to utilize the list as a whitelist for a security-related tool that is operating within the organizational network.

19. The computerized apparatus of claim 18, wherein said utilizing comprises transmitting the list to the plurality of devices, each of which having the security-related tool installed thereon, wherein the security-related tool is configured to perform selective blocking of communications of programs based on the list.

20. A computer program product comprising a non-transitory computer readable storage medium retaining program instructions, which program instructions when read by a processor, cause the processor to perform a method comprising:
monitoring programs executed by a device within an organizational network, to identify an attempt to transmit outgoing communications;
in response to determining a program executed by the device is attempting to transmit an outgoing communication:
checking whether the program is listed in a base list of authorized programs;
in response to determining that the program is listed in the base list, adding the program to a list of authorized programs.
